(19) United States
(12) Patent Application Publication
(10) Pub. No.: US 2013/0139476 A1
(43) Pub. Date: Jun. 6, 2013

(54) ACRYLIC FORMATION PROCESS FOR MARINE ENCLOSURE FABRICATION

(71) Applicant: Jeffrey Smith, Crownsville, MD (US)

(72) Inventor: Jeffrey Smith, Crownsville, MD (US)

(21) Appl. No.: 13/707,567

(22) Filed: Dec. 6, 2012

Related U.S. Application Data
(60) Provisional application No. 61/567,546, filed on Dec. 6, 2011.

(51) Int. Cl. B65D 25/00; B65B 5/00; C09K 3/10

(52) U.S. Cl. CPC B65D 25/00; C09K 3/10; B65B 5/00
USPC 53/473; 252/587; 156/244.11; 156/244.18

(57) ABSTRACT

An acrylic material can block up to about 98% of ultraviolet wavelength radiation from passing through. The acrylic material can also be produced to block a substantial amount of infrared energy, resulting in a material that can be used to fabricate an enclosure that can keep occupants cool and safe from harmful ultraviolet radiation. The acrylic can be manufactured from an acrylic mix containing elements of ultraviolet blocking and infrared blocking technology. The acrylic mix can be extruded in various dimensions and thicknesses, depending on application. For marine enclosure applications, the sheets can be formed in 60-inch by 120-inch by 0.080 inch thick sheets.

### CROSS-REFERENCE TO RELATED APPLICATION

This application claims the benefit of priority of U.S. provisional application No. 61/567,546, filed Dec. 6, 2011, the contents of which are herein incorporated by reference.

### BACKGROUND OF THE INVENTION

The present invention relates to marine enclosures and marine enclosure fabrication processes and, more particularly, to an ultraviolet (UV) and infrared (IR) blocking acrylic formation process for marine enclosure fabrication.

Enclosures on boats are extremely hot and transmit harmful UV radiation because boating is an outdoor activity that is predominantly conducted on hot, sunny days.

Present acrylics expose occupants to harmful UV-A rays that is a known factor in melanoma, cataracts, macular degeneration and adversely effects the results of drugs used for many ailments. These rays can also do damage to the interior portion of the enclosure, including damaging chart books and the like. Acrylics also let infrared heat penetrate and increase the temperature of persons exposed. Present acrylics available in a form for fabrication of marine boat or yacht enclosures only block about 70% of the ultraviolet rays and do not block infrared heat energy.

As can be seen, there is a need for an improved marine enclosure and marine enclosure fabrication process that can block ultraviolet and infrared energy from passing.

### SUMMARY OF THE INVENTION

In one aspect of the present invention, an acrylic panel for forming an enclosure comprises one or more acrylic sheets formed by a extruding acrylic pellets having ultraviolet blocking elements and infrared blocking elements, wherein the one or more acrylic sheets blocks at least 90% of ultraviolet radiation from passing therethrough.

In another aspect of the present invention, a method for making an enclosure comprises extruding acrylic pellets having ultraviolet blocking elements and infrared blocking elements into one or more acrylic sheets; forming the enclosure with at least one of the one or more acrylic sheets; and preventing at least 90% of ultraviolet radiation from passing through the acrylic pellets with the ultraviolet blocking elements molded into the one or more acrylic sheets.

These and other features, aspects and advantages of the present invention will become better understood with reference to the following drawings, description and claims.

### BRIEF DESCRIPTION OF THE DRAWINGS

FIG. 1 is a schematic representation of an acrylic formation process according to an exemplary embodiment of the present invention;

FIG. 2 is a flow chart describing steps in the formation of acrylic sheets according to an exemplary embodiment of the present invention; and

FIG. 3 is a cross-sectional view of an acrylic sheet formed by the process of the present invention, illustrating the reflection of ultraviolet and infrared energy therefrom.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an acrylic material that can block up to about 98% of ultraviolet wavelength radiation from passing through. The acrylic material can also be produced to block a substantial amount of infrared energy, resulting in a material that can be used to fabricate an enclosure that can keep occupants cool and safe from harmful ultraviolet radiation. The acrylic can be manufactured from an acrylic mix containing elements of ultraviolet blocking and infrared blocking technology. The acrylic mix can be extruded in various dimensions and thicknesses, depending on application. For marine enclosure applications, the sheets can be formed in 60-inch by 120-inch by 0.080 inch thick sheets.

The acrylic of the present invention can produce an enclosure, for example, a marine enclosure, with ultraviolet and infrared blocking technology that can keep occupants nearly 10 degrees cooler than conventional enclosures.

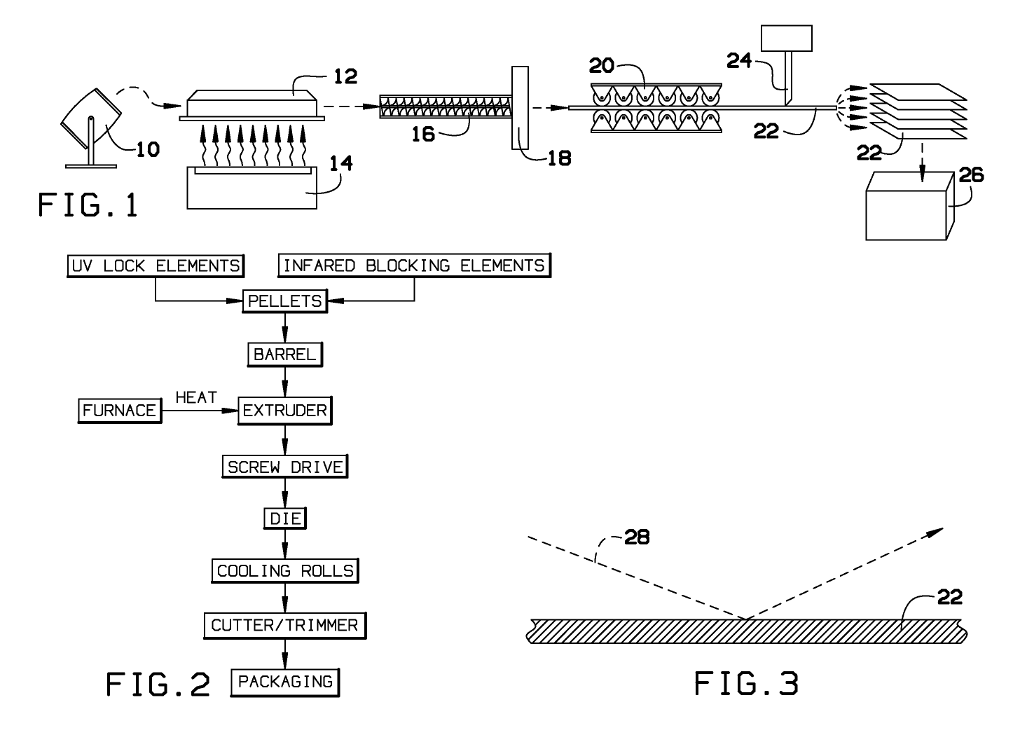

Referring now to FIGS. 1 and 2, an exemplary method for making an acrylic sheet for enclosures is shown and described. First, an acrylic mix is formed that includes ultraviolet blocking elements and infrared blocking elements. This acrylic mix can be formed as pellets and fed into a barrel 10 of an extruder 12. A furnace 14 can heat the pellets until they are a molten mass. The resulting molten mass is then slowly pushed by a screw drive 16 and forced out through a die 18 as a molten sheet, the spacing of which determines the thickness of the sheet. Typically, the sheet thickness is 0.080 inch, but, in some embodiments, a thickness from about 0.049 to about 0.098 inch could be used, for example.

The continuous band of acrylic sheet can pass through a set of cooling rollers 20 and can be cut or trimmed to its final size with a cutter 24. Typically, this final size can be a sheet that is 60-inch by 120-inch, although other sizes can be chosen within the scope of the present invention.

The resulting sheets 22 can be masked on each side and wrapped, typically five sheets together, in plastic to prevent humidity intrusion. The wrapped five sheets can be wrapped and packaged in a cardboard box 26 as a case product that can be effectively handled and shipped to fabricators.

In some embodiments, the acrylic could be extruded in 10-foot widths and cut down to 5-foot widths, or variations thereof, to produce sheets usable in different applications.

As shown in FIG. 3, when impinged upon by ultraviolet and/or infrared radiation 28, this radiation can be reflected by the sheet 22, rather than passing through the sheet 22. The sheet 22 can block at least 90% of ultraviolet radiation from passing therethrough. Typically, the sheet can block about 95% of ultraviolet radiation. Often, the sheet can block up to about 98% of ultraviolet radiation.

The resulting sheet can be cut according to shapes dictated by patterns taken from the vessel, and border fabrics are bonded to all four edges, enabling zippers, welt, snaps and other fasteners to be attached to the fabric. The finished enclosure is then able to be installed on the vessel, utilizing the zipper, welt, snaps, or the like. The installed enclosure protects occupants from harmful ultraviolet radiation and comforts them by blocking substantial infrared heat.

The finished panels can be installed in various applications, such as an awning application that can provide occupants the same protection afforded that of vessels. The same finished panels could be installed on tractors. The panels could also be utilized in a fence application, providing ultraviolet protection and cool comfort to those in pool settings and the like. The panels could also be used to enclose porches and other similar areas, allowing light to brighten the interior while minimizing harmful ultraviolet or temperature raising infrared radiation from passing through. The panels of the present invention could be useful in applications where persons need sunlight for psychological stability, while needing protection from ultraviolet radiation for physical wellness.

It should be understood, of course, that the foregoing relates to exemplary embodiments of the invention and that modifications may be made without departing from the spirit and scope of the invention as set forth in the following claims.

What is claimed is:

1. An acrylic panel for forming an enclosure, comprising:
one or more acrylic sheets formed by a extruding acrylic pellets having ultraviolet blocking elements and infrared blocking elements, wherein
the one or more acrylic sheets blocks at least 90% of ultraviolet radiation from passing therethrough.

2. The acrylic panel of claim 1, wherein the one or more acrylic sheets block about 98% of the ultraviolet radiation from passing therethrough.

3. The acrylic panel of claim 1, wherein the enclosure is a marine enclosure.

4. The acrylic panel of claim 1, wherein the one or more acrylic sheets block at least a portion of infrared radiation from passing therethrough.

5. A method for making an enclosure, comprising:
extruding acrylic pellets having ultraviolet blocking elements and infrared blocking elements into one or more acrylic sheets;
forming the enclosure with at least one of the one or more acrylic sheets; and
preventing at least 90% of ultraviolet radiation from passing through the acrylic pellets with the ultraviolet blocking elements molded into the one or more acrylic sheets.

6. The method of claim 5, further comprising blocking about 98% of the ultraviolet radiation from passing through the one or more acrylic sheets.

7. The method of claim 5, wherein the enclosure is a marine enclosure.

8. The method of claim 5, wherein further comprising blocking at least a portion of infrared radiation from passing through the one or more acrylic sheets.

9. The method of claim 5, further comprising passing extruded acrylic sheets through rollers for cooling.

10. The method of claim 9, further comprising cutting cooled acrylic sheets to desired sizes.

11. The method of claim 10, further comprising packaging five cut acrylic sheets in packaging.
